(19) United States
(12) Patent Application Publication
(10) Pub. No.: US 2023/0028897 A1
(43) Pub. Date: Jan. 26, 2023

(54) SYSTEM AND METHOD FOR CAPTION VALIDATION AND SYNC ERROR CORRECTION

(71) Applicant: VENERA TECHNOLOGIES INC., Burbank, CA (US)

(72) Inventor: Rajarshi MUKHOPADHYAY, Greater Noida (IN)

(73) Assignee: VENERA TECHNOLOGIES INC., Burbank, CA (US)

(21) Appl. No.: 17/536,564

(22) Filed: Nov. 29, 2021

(30) Foreign Application Priority Data
Jul. 8, 2021 (IN) 202141030745

(51) Int. Cl. G06F 40/279; G10L 15/26; H04N 17/00

(52) U.S. Cl. CPC G06F 40/279; G10L 15/26; H04N 17/00

(57) ABSTRACT

Disclosed is a system and method for validating and correcting sync errors of captions of a media asset comprising a caption file, wherein each caption has a start time and an end time. The system decodes the caption file using caption decoder for generating a format agnostic XML file, a transcriber engine extracts an audio track and transcribes the audio for generating a transcript, a caption analyser identifies matching set of words in the transcript and assign a match score and classifies the captions as one of MATCHING and UNDETECTED based on the match score. The caption analyser determines sync offset for each caption that is classified as MATCHNING and the system uses a prediction engine for predicting sync offset of the captions that are classified as UNDETECTED.

### PRIORITY

This Patent application claims priority from the Indian provisional Patent Application No. 202141030745 filed on Jul. 8, 2021.

### TECHNICAL FIELD

The present invention generally relates to media validation and more particularly to a system and method for caption validation and correcting caption sync errors in a media asset.

### BACKGROUND

Multimedia assets such as news, movies, songs, television shows, etc., are typically transmitted to consumer devices for displaying and presenting to the one or more consumers. Such multimedia assets often include captions, which are the text versions of the audible part of the multimedia, to aid hearing-impaired people and may be used for many other purposes for example for learning non-native languages. In other words, the captions are an integral part of the media asset delivery and essentially describes the on-screen sound comprising of spoken audio as well as non-spoken audio such as background sound, name of the on-screen characters, etc. The captions are typically delivered in two ways namely in-band means where caption data is part of the audio/video data, for example EIA608/708 or as a side car (out of band means), that is, as a file along with the audio/video files. There are various caption formats used in the industry, some of which are as per standards such as EIA-608/708, TTML, EBU-TT, SMPT-TT etc., and there are many standards which are proprietary in nature.cap, .scc, .srt, etc.

Irrespective of formats and the delivery methods, it is important that the captions and the audio be correctly aligned to provide a rich user experience. In other words, in order to make a seamless presentation of the media and captions, it is imperative to maintain the presentation of the caption data in sync with the on-screen audio, especially the spoken audio. However, the captions generated by the human experts and the automated speech recognition software often include time lags. Hence, it is a commonly occurring problem in the industry, where the captions are often found out of sync with the on-screen audio leading to bad viewing experience. Although, a few captions getting out of sync may not be much of a problem, a large number of out of sync captions with respect to the on-screen audio leads to a bad viewing experience.

As described, one of the reasons for sync errors may be time lag introduced by the human experts or the automated speech recognition software. Another reason for sync errors is content repurposing. As the content is often repurposed which involves trans-coding or minor editing, etc., the same needs to be taken care for the caption files that are associated with the content. It is often found that the side car captions are not modified as per the new content that has been repurposed, thereby leading to sync anomalies spread across all the captions, leading to a bad user experience. In addition, sync errors may be induced by the system which could be due to frame rate conversion leading to drift, or due to stitching of different segments of video from a master content leading to segment-wise sync offset errors. Such errors may be referred to as pervasive errors as these are spread uniformly across the timeline, and the other type of errors may be referred to as sparse errors since such errors are sparse in nature and their occurrences are few. Manually fixing any such sync errors is a time-consuming process, is error prone and becomes a major bottleneck in delivery.

Furthermore, it is important to note that the caption sync errors induced due to processes such as frame rate conversion or editing of the original content wherein the side car caption timings have not been appropriately modified leads to systematic errors which spread across a large number of captions. Fixing such sync errors through manual review and editing for such large a number of captions is consuming process.

Even though there exist a few sync error detection tools, such tools require transcription data for each caption. However, there are multiple reasons for not having transcriptions for every caption, the reasons including-unclear audio which cannot be readily recognized by the speech engine, captions may not pertain to spoken audio rather describes the non-speech content such as background music or describing the name of on-screen characters, etc., In such a scenario, the captions often include undetected sync errors as they cannot be matched with the generated transcriptions. Hence, the conventional methods and tools often fail to detect the caption sync errors.

### BRIEF SUMMARY

This summary is provided to introduce a selection of concepts in a simple manner that is further described in the detailed description of the disclosure. This summary is not intended to identify key or essential inventive concepts of the subject matter nor is it intended for determining the scope of the disclosure.

To overcome at least one of the problems mentioned above, there exists a need for a system and a method for caption validation and sync error correction.

The present disclosure discloses a system and a method for validating captions and correcting sync errors of captions of a media asset comprising a caption file, wherein each caption has a start, time and an end time. The method comprises, extracting an audio track from the media file and transcribing the audio for generating a transcript, wherein each word in the transcript comprises a start time and an end time, comparing each caption with the transcript for identifying matching set of words in the transcript and assigning a match score based on a result of the comparison, classifying each caption as one of MATCHING and UNDETECTED based on the match score, determining sync offset between the captions classified as MATCHING and the matched set of words of the transcript, by calculating differences in start time and the end time of each caption classified as MATCHING and the start time and the end time of the matched set of words of the transcript, storing each caption in a result database with metadata, wherein the metadata includes classification of each caption, matched set of words in the transcript, and the sync offset, and segmenting the captions and applying a prediction model on each segment for predicting possible sync offset of the captions classified as UNDETECTED and updating the result database.

Further, the system for validating captions of the media asset comprises, a caption decoder configured for decoding the caption file for generating a format agnostic XML, file, a transcriber engine configured for extracting an audio track from the media file and transcribing the audio for generating a transcript, wherein each word in the transcript comprises a start time and an end time, a caption analyser configured for, comparing each caption with the transcript for identifying matching set of words in the transcript and assigning a match score based on a result of the comparison, classifying each caption as one of MATCHING and UNDETECTED based on the match score, determining sync offset between the captions classified as MATCHING and the matched set of words of the transcript, by calculating differences in start time and the end time of each captions classified as MATCHING and the start time and the end time of the matched set of words of the transcript, storing each caption along with its metadata in a result database, wherein the metadata includes classification of each caption, matched set of words in the transcript, and the sync offset, and a prediction engine configured for segmenting the captions and applying a prediction model on each segment for predicting possible sync offset of the captions classified as UNDETECTED and updating the result database.

To further clarify the advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosed method and system will be described and explained with additional specificity and detail with the accompanying figures in which:

FIG. 1 is a block diagram of the system for caption validation and sync error correction in accordance with an embodiment of the present disclosure;

FIGS. 2A and 2B are flow charts illustrating the operations of the caption analyser 135 in accordance with an embodiment of the present disclosure;

FIG. 2C illustrates text matching method in accordance with an embodiment of the present disclosure;

FIG. 3 is an exemplary interface showing data stored in the result database in accordance with an embodiment of the present disclosure; and

FIG. 4 is a flowchart illustrating the functions of the prediction engine 140 in accordance with an embodiment of the present disclosure.

Further, persons skilled in the art to which this disclosure belongs will appreciate that elements in the figures are illustrated for simplicity and may not have been necessarily drawn to scale. Furthermore, in terms of the construction of the joining ring and one or more components of the bearing assembly may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

In the present disclosure, relational terms such as first and second, and the like, may be used to distinguish one entity from the other, without necessarily implying any actual relationship or order between such entities.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more elements or structures or components preceded by “comprises . . . a” does not, without more constraints, preclude the existence of other elements, other structures, other components, additional devices, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The components, methods, and examples provided herein are illustrative only and not intended to be limiting.

Embodiments of the present disclosure will be described below in detail with reference to the accompanying figures.

Embodiments of the present disclosure disclose a system and a method for caption validation and sync error correction, wherein the system detects the sync errors using caption data, audio transcription data, and prediction model generated from the caption data and the audio transcription data, and then transforms the caption data having the sync errors into sync corrected caption data. Particularly, the system decodes a media asset comprising a caption file having a plurality of captions, extracts an audio track from the media file and transcribes the audio for generating a transcript, compares each caption with the transcript for identifying matching set of words in the transcript and assigns a match score, classifies each caption as one of MATCHING and UNDETECTED based on the match score, determines sync offset between the captions classified as MATCHING and the matched set of words of the transcript by calculating differences between start time and end time of caption and matched set of words, stores each caption in a result database with metadata, and segments the captions and applies a prediction model on each segment for predicting possible start time (sync offset) of the captions classified as UNDETECTED.

As described, a media asset comprises a caption file along with video and audio data, and the caption file comprises a plurality of captions. Each caption may include any number of words optionally with special symbols, numbers, or combination thereof. A caption is also referred to as a subtitle and the caption file comprises start time and end time of each caption. The term sync offset is a difference in time between the caption start time and the corresponding on-screen audio start time. The system disclosed in the present disclosure determines such sync offset by comparing differences in start time and the end time of each caption with start time and the end time of matching sets of words in the transcript. The system further builds a prediction model for the captions for which matching set of words are unavailable in the transcript and uses the prediction model for predicting the sync offset. The way the system validates the captions and corrects the sync errors is described in detail with reference to the accompanying figures.

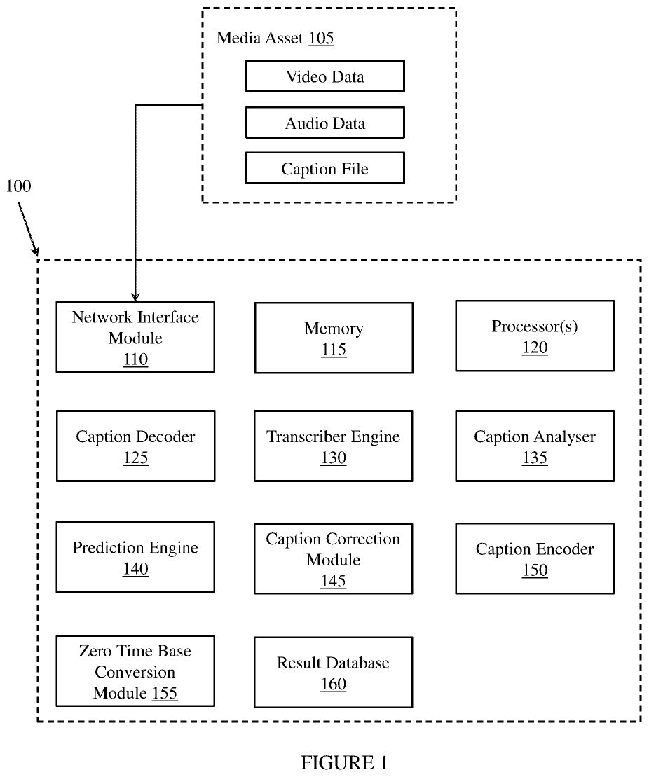

FIG. 1 is a block diagram of the system for caption validation and sync error correction in accordance with an embodiment of the present disclosure. As shown, the system 100 comprises a network interface module 110, a memory 115, one or more processors 120, a caption decoder 125, a transcriber engine 130, a caption analyser 135, a prediction engine 140, a caption correction module 145, a caption encoder 150, a zero-time base conversion module 155 and a result database 160.

The system 100 for caption validation and sync error correction may include, for example, a mainframe computer, a computer server, a network of computers, or a virtual server. In one implementation, the system 100 is a computer server comprising one or more processors 120, associated processing modules, interfaces, and storage devices communicatively interconnected to one another through one or more communication means for communicating information. As shown, the network interface module 110 enables communication with the external devices such as media asset server or any computing devices for receiving the media assets and to communicate the corrected caption files. That is, the system 100 is communicatively connected to external devices through a communication network (not shown) for receiving the media asset from an end user and for communicating the corrected caption files. The memory 115 associated with the system 100 may include volatile and non-volatile memory devices for storing information and instructions to be executed by the one or more processors 120 and for storing temporary variables or other intermediate information during processing.

As shown, the system 100 receives media asset 105 as an input, performs caption validation and sync error correction to produce a corrected caption file, wherein the corrected caption file includes caption data synced with the audio data. The media asset 105 may be one of a news, movies, songs, television shows, and the like, and comprises video data, audio data or both along with the caption file. The way the system 100 validates the captions, corrects the sync errors, and produces the corrected caption file is described below in further detail.

Referring to FIG. 1, on receiving the media asset 105, the processor 120 decodes the media asset 105 to get the audio stream (audio track) and the caption file. The audio track is then input to the transcriber engine 130 and the caption file is input to the caption decoder 125 for further processing.

The caption file may be in any known format such as EIA-608/708, TTML, EBU-TT, SMPT-TT etc., and other proprietary standards such .cap, .scc, .srt, etc. In one embodiment of the present disclosure, the caption decoder 125 decodes the caption file based on the encoding format and converts caption file into a format agnostic XML based metadata. The XML metadata file comprises nodes corresponding to each caption and the timings, that is, a start time and an end time. Other properties constitute the attributes of the nodes, and the caption text serves as the value of the node. The XML metadata file is input to the caption analyser 135. As described, the caption file comprises the plurality of captions and each caption may include any number of words and optionally with special symbols, numbers, or combinations thereof. A caption is also referred to as a subtitle and the caption file comprises start time and end time of each caption.

The transcriber engine 130 is configured for converting the speech in the audio stream into a text transcript. It is to be noted that the transcriber engine 130 may be any speech engine which is suitable for language specific speech recognition. The text transcript (herein after referred to as transcript) generated by the transcriber engine 130 comprises sentences followed by word array as recognized by the speech engine along with s start time and an end time of each word. The generated text transcript is input to the caption analyser 135.

The caption analyser 135 is configured for analysing the XML, metadata file and the transcript for detecting the sync offsets between the captions and text transcript, that is, between the captions and the audio stream. In one embodiment of the present disclosure, on receiving the XML metadata file and the transcript, the caption analyser 135 analyses the same to detect caption sync offsets for those captions for which a matching set of words are available in the transcript. In another embodiment of the present disclosure, the caption analyser 135 generates a prediction model for detecting the caption sync offsets for those captions for which a matching set of words are not available in the transcript. Since there may be many captions for which there may not be matching set of words available for reasons such as unclear audio, audio overlap person speaking while music playing in the background, etc., for example. Such a scenario is termed as UNDETECTED (in the present disclosure) as far as sync error is concerned. In such a scenario, that when the matching set of words (matching transcripts) are unavailable (pervasive error), the caption analyser 135 employs prediction model to predict caption sync offsets thereby increasing the prediction rate significantly. Upon detecting and predicting the caption sync offsets, caption sync offset data is input to the caption correction module 145, wherein the caption sync offsets data comprises at least the caption or caption identifier, detected time difference, predicted time difference, etc. The way the caption analyser 135 detects the caption sync offsets is described below in further detail.

Upon detecting the caption sync offsets, the caption correction module 145 modifies the caption timings, that is, the start time and end time of each caption, based on the caption sync offset data, that is, the detected and predicted time differences between the original caption timings and the actual caption timings. In one embodiment of the present disclosure, the caption correction module 145 removes the overlapping of captions by modifying the end time of previous caption. The caption correction module 145 produces a corrected XML metadata file comprising the corrected caption timings. The caption encoder 150 then receives the corrected XML metadata file and encodes the same as per the input format of the caption file.

As described, the caption analyser 135 detects the caption sync offsets for the captions for which the matching set of words are available in the transcripts by computing the differences in the start time and the end time of each caption with the start time and the end time of the matched set of words of the transcript. For captions for which the matching set of words are unavailable in the transcript, the caption analyser 135 uses the prediction model generated by the prediction engine 140. The way the caption analyser 135 validates the captions for detecting the caption offsets is described below in further detail.

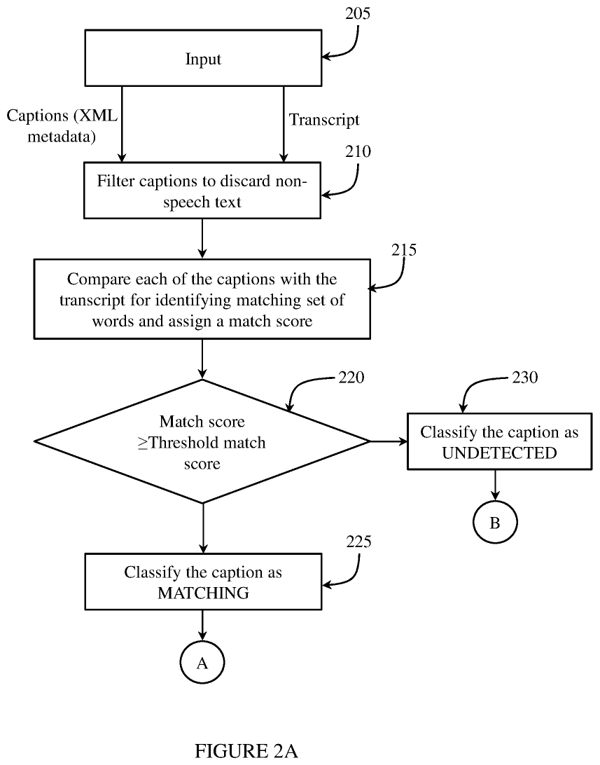

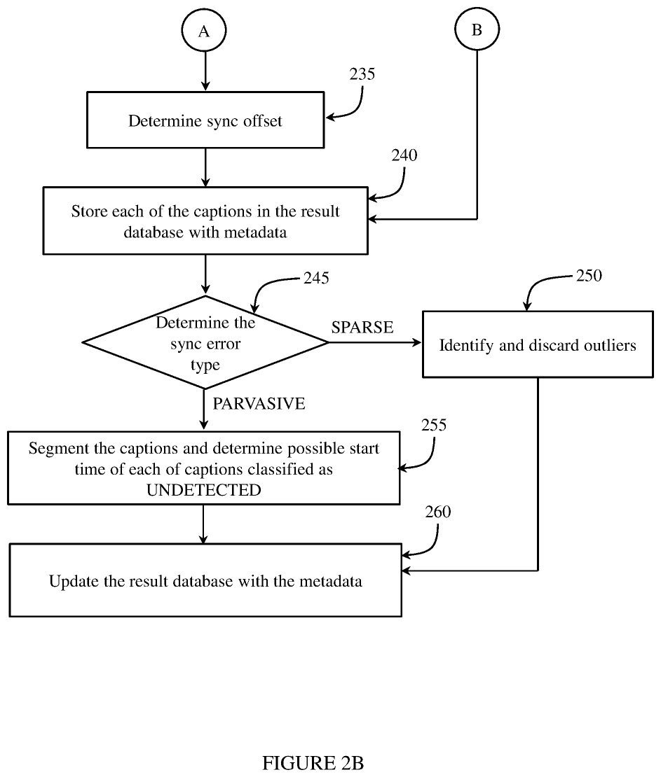

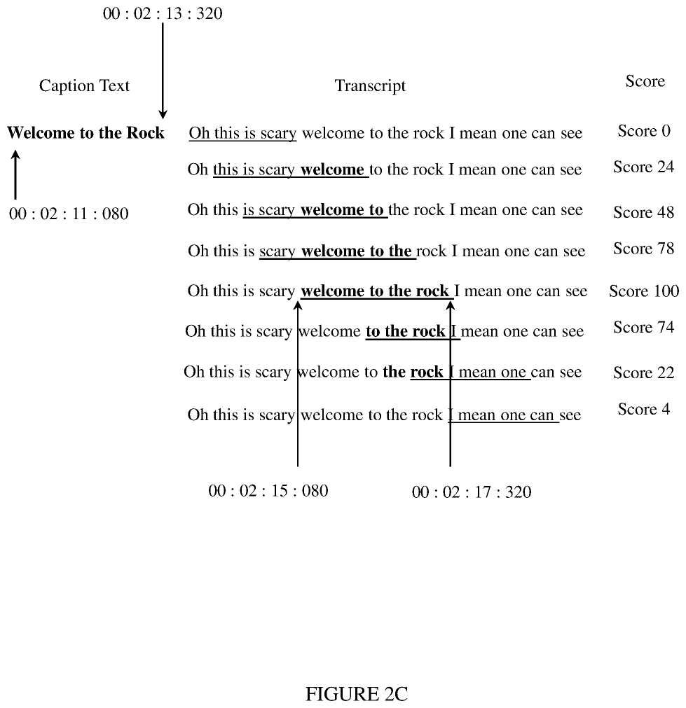

FIGS. 2A and 2B are flow charts illustrating the operations of the caption analyser 135 in accordance with an embodiment of the present disclosure. As shown at step 205, the inputs to the caption analyser 135 are the XML metadata file containing the captions and the transcript generated by the transcriber engine 130. As described, the XML metadata file comprises captions along with the start time and the end time of each caption. Further, the transcript comprises sentences followed by word arrays as recognized by the speech engine along with the start time and the end time of each word.

At step 210, in one embodiment of the present disclosure, the caption analyser 135 filters the captions to discard non-speech text from the captions. That is, the caption analyser 135 filters the captions to remove the non-speech content in the captions and to retain only the speech content for further processing. As well known, the captions may include texts related to non-speech content such as character name, text on song playing in the background, text describing a context, etc. Hence, to make the matching of caption with that of the transcription (text transcript) accurate, the captions are sanitized to ensure that only speech texts are part of the matching process. As part of this process, the non-speech text which are normally decorated using various special symbols such as [ ] or musical notation symbols [symbol] , etc., are identified and discarded as shown at step 210.

At step 220, after filtering, the caption analyser 135 compares each caption with the transcript for identifying matching set of words in the transcript and assigns a match score. That is, the text matching logic of the caption analyser 135 takes the captions along with the time values and the logic starts from the last successful index of comparison in the transcription list. In one embodiment, given “N” words of a caption, the text matching logic uses “N” words from the transcription list and forms a reference string against which the comparison is to be performed. That is, the text matching logic compares a caption with a set of N words of the transcript wherein N is equal to a number of words in the caption numbered from 0 to N out of M words of the transcript and assigns a score based on a result of the comparison. The above step is repeated by considering the caption with a new set of N words formed by 1 to N+1 words of the M words until a highest score is reached and the highest score is assigned as the match score of the caption. This process is repeated for all the captions. The above method of comparison is explained in detail with an example.

FIG. 2C illustrates text matching method in accordance with an embodiment of the present disclosure. In this example, the text matching logic selected a caption having four words and uses the four words from the transcript and forms a reference string (reference set of words) against which the comparison is to be performed. Then, the text matching logic tries to find closest match for each word and assigns a score. In this example, for the selected four words in the caption text, there is no match in the first four words in the transcript and hence assigns a score zero. Then, the reference word window (text transcript) as described herein is shifted by one word, that is, the first word is shifted out and a new word is appended to the reference list and a new reference set of words is formed. Again, the text matching logic performs comparison and assigns a score. This process continues till the end of the transcript. The one with the highest match score is chosen and assigned as the match score of the caption.

At step 220, the caption analyser 135 compares the match score of the caption with a threshold match score and classifies the caption as one of MATCHING and UNDETECTED based on a result of comparison as shown in step 225 and 230. The above steps of comparison of caption with the transcript for identifying matching set of words and assigning a match score, comparison of the match score with the predefined threshold and classification of the caption is repeated for all the captions in the caption file and the results are stored in the result database 160.

Referring to FIG. 2B, at step 235, the caption analyser 135 determines sync offset of all the captions that are classified as MATCHING. In one embodiment of the present disclosure, the caption analyser 135 determines the sync offset between each caption classified as MATCHING and the matched set of words of the transcript by calculating differences in start time and the end time of each caption classified as MATCHING and the start time and the end time of the matched set of words of the transcript. For example, referring to FIG. 2C, the caption “welcome to the Rock” is classified as MATCHING since it has a matching set of words in the transcript. For all such captions, the caption analyser 135 determines sync offset.

In this example, the start time of the caption is 00:02:11.080 (HH:MM:SS:MSS or Hours:Minutes:Second:Milliseconds) and the end time is 00:02:13.320, and the start time of the matched set of words in the transcript is 00:02:15.080 and the end time is 00:02:17.320.

The caption analyser 135 calculates the difference in the start time and the end time, which is +00:00:02:00 in this example, which is the sync offset of the given caption. Similarly, the caption analyser 135 determines sync offset of all captions that are classified as MATCHNING, in other words, of all the captions for which the matching set of words are available in the transcript.

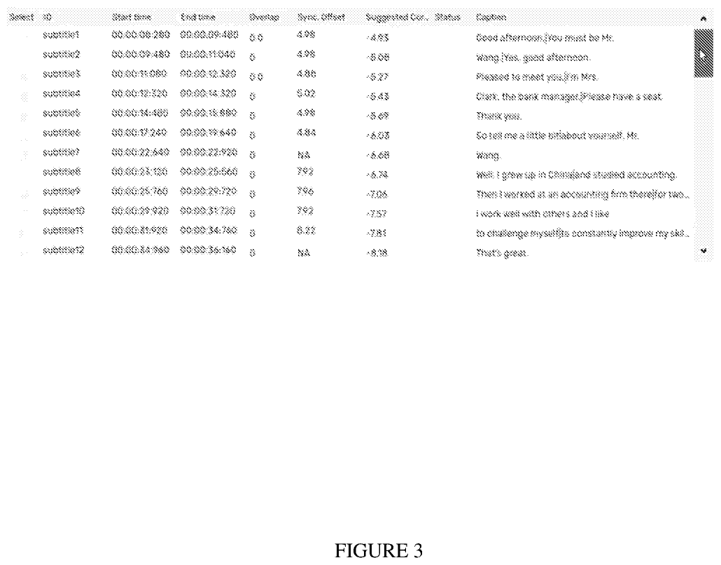

At step 240, the caption analyser 135 stores each caption in the result database 160 along with metadata, wherein the metadata includes classification of each caption, matched set of words in the transcript, and the sync offset. That is, all the captions that are classified as MATHCNING and UNDETECTED are stored in the result database 160 along with the metadata. FIG. 3 is an exemplary interface showing data stored in the result database in accordance with an embodiment of the present disclosure. As shown, all the captions are stored along with their metadata, the metadata include caption ID, start time and end time, sync offset (for the caption classified as MATCHING), matching set of words associated with each caption (not shown), etc. In this example, captions for which the matching set of words are unavailable in the transcript are denoted as NA (UNDETECTED) as shown.

Often, in the broadcasting world, the caption time base starts with a fixed offset such as one hour or any other random value to denote play-out time. Since the media time, in this case the audio based on which the text transcript (transcription list) has been generated, is based on zero-time base, it is imperative to bring the time base of all captions to zero-time base in order to do a proper sync analysis.

Referring to FIG. 1, the zero-time base conversion module 155 uses first few outputs (of the first few captions) and the metadata stored in result database 160 for identifying the fixed offset, if any. The initial number of captions for which the text matching should be done could be any small number X. For such “X” successful comparison of text matching the sync offset value is noted. Once data for “X” successful comparison is obtained, the zero-time base conversion module 155 obtains mode and the mode count for “X” samples. If mode count is greater than 50% of “X” samples then, it is inferred as the initial offset. This sync offset is then applied to all the caption timings to bring the captions to the zero-time base. The output of this process is the modified XML data with all caption timings converted to zero-time base and this will be the input 205 to the caption analyser 135 as shown in step 210 in FIG. 2A.

As described, the caption analyser 135 stores each caption along with the metadata in the result database 160, wherein the metadata includes classification of each caption, matched set of words in the transcript, and the sync offset. In one embodiment of the present disclosure, the caption analyser 135 determines a sync error type as shown at step 245. In one implementation, the caption analyser 135 initially determines sync errors using the metadata stored in the result database 160. In one embodiment, the caption analyser 135 determines the sync error of a caption by comparing the sync offset value with a predefined tolerance value and flags the caption as ERRONEUOS if the sync offset value is greater than the predefined tolerance value. In one example, considering the predefined tolerance value as one second, the caption analyser 135 flags all the captions having sync offset value greater than one second. Then, the caption analyser 135 counts the number of captions having sync error and determines the sync error type as PERVASIVE if the count is greater than or equal to a predefined count (predefined value), else marks as SPARSE.

In one embodiment of the present disclosure, if the sync error type is SPARSE, that is, if the sync errors are sparse in nature and their occurrences are few, then the caption analyser 135 identifies the outliers in the result database 160, discards the same and updates the result database 160 with the metadata. The outliers as described herein refers to the sync offset having incorrect values, which may be due to repetition of captions. In one embodiment of the present disclosure, the outliers are detected by z-score method and the outliers are discarded during caption correction. Then, the result database 160 is updated with the metadata as shown in step 260.

In one embodiment of the present disclosure, if the sync error type is PERVASIVE, then the caption analyser 135 uses the prediction engine 140 for predicting possible start time of the captions that are classified as UNDETECTED. As shown at step 255, the prediction engine 140 segments are captions and determine possible start time of each of captions classified as UNDETECTED by applying a prediction model on each segment. Then, the prediction engine 140 updates the result database 160 with the predicted possible start time of each caption that is classified as UNDETECTED. The manner in which the prediction engine 140 predicts the possible start time is described below in further detail. It is to be noted that the sync error type detection process is optional, that is, the prediction method may be applied even if the number of sync errors are less in number.

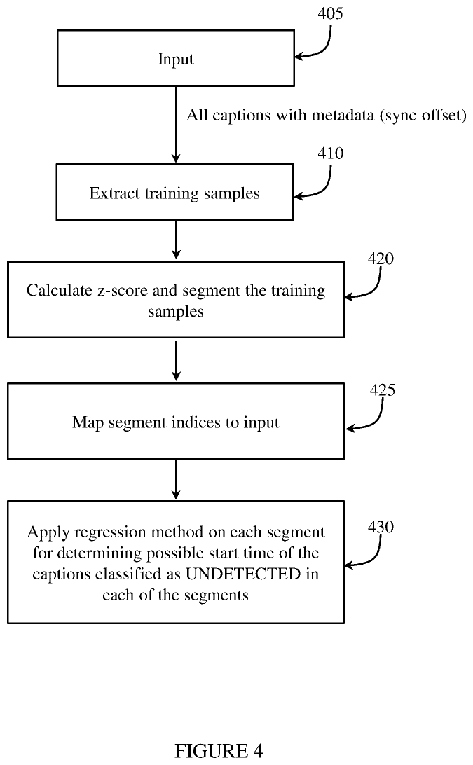

FIG. 4 is a flowchart illustrating the functions of the prediction engine 140 in accordance with an embodiment of the present disclosure. At step 405, the prediction engine 140 receives an input for building the prediction model, wherein the input comprises all the captions with metadata updated in the result database 160. It is to be noted that the outliers are detected and removed from the input as described, using the z-score method.

At step 410, the prediction engine 140 extracts training samples from the input, wherein the training samples are the detected sync offset values, that is, the captions having sync offset. In other words, captions having zero sync offset value are discarded and other captions are considered as the training samples for building the prediction model.

At step 410, the prediction engine 140 calculates z-score and identifies segments in the training samples using the z-score. That is, in one embodiment of the present disclosure, the prediction engine 140 calculates z-score for each sample, determines differential z-score by calculating z-score difference between previous and next sample, and identifies the segments in the training samples using the differential z-score. In one embodiment of the present disclosure, for each sample, the previous z-score difference and next z-score difference is considered and if the previous z-score difference and the next z-score difference is less than a threshold z-score (a predefined value), then the sample is considered as part of the current segment. If the next z-score difference is less than the threshold but previous z-score difference is more than the threshold z-score, then the sample indicates beginning of a new segment. On the other hand, if the next z-score difference is more than the threshold z-score but the previous z-score difference is less than the threshold score, then the sample indicates end of the current segment.

At step 425, the prediction engine 140 maps the segment indices to the input. That is, once all the segments are identified, in other words, once the prediction engine 140 segments the training samples, the segment indices are mapped to the input. Once mapped, the input includes multiple segments, wherein each segment includes both detected sync offsets (captions with detected sync offset) and undetected ones (captions classified as UNDETECTED).

At step 430, the prediction engine 140 applies linear regression on each segment for detecting possible start time of the captions classified as UNDETECTED in each of the segments. That is, the prediction engine 140 applies linear regression on a given segment by calculating regression coefficients based on the training sample in the segment, and then the regression coefficients on the captions classified as UNDECTED in that segment for determining possible sync offset (possible start time). Then, the prediction engine 140 updates the result database 160 with the metadata, that is, the sync offset values of the captions that are classified as UNDECTED.

Once the sync offsets are predicted for the captions that are classified as UNDETECTED, the caption analyser 135 determines the sync error of by comparing the sync offset value with the predefined tolerance value and flags the caption as ERRONEUOS if the sync offset value is greater than the predefined tolerance value as described in the present disclosure.

Once the caption analyser 135 determines the sync errors, in other words, identifies the captions having sync error, the caption correction module 145 uses the sync offset values of the captions for correcting the sync errors. That is, the caption correction module 145 modifies the start time of the captions that are having sync errors, using the sync offset value and generates a corrected XML metadata. Then, caption encoder 150 encodes the corrected XML metadata into a new caption file in the same encoding format as the input encoding format.

As described, the method and system disclosed in the present disclosure automatically brings the non-zero time-based captions into zero-time based captions, detects caption sync offsets of the captions for which the matching set of words are available in transcript, generates a prediction model for the captions for which the matching set of words are unavailable in the transcript and uses the prediction model to predict the possible sync offset of the captions for which the matching set of words are unavailable in the transcript. Then determines the sync errors by comparing the sync offset values with the predefined tolerance value and generates a corrected caption file using the caption sync offset values, thereby increasing the correction rate.

It may be noted that terms such as MATCHING, UNDETECTED, ERRONEOUS, PERVASIVE, SPARSE, etc., are only names used to describe the subject for intuitive understandability. The names are unimportant and a person skilled in the art may use any other names to identify the different states and conditions, as described herein.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method for validating captions of a media asset comprising a caption file, wherein each caption has a start time and an end time, the method comprising:
a step of extracting an audio track from the media asset and transcribing the audio for generating a transcript, wherein each word in the transcript comprises a start time and an end time;
a step of comparing each caption with the transcript for identifying matching set of words in the transcript and assigning a match score based on a result of the comparison;
a step of classifying each caption as one of MATCHING and UNDETECTED based on the match score;
a step of determining sync offset between the captions classified as MATCHING and the matched set of words of the transcript, by calculating differences in start time and the end time of each caption classified as MATCHING and the start time and the end time of the matched set of words of the transcript;
a step of storing each caption with its metadata in a result database, wherein the metadata includes classification of each caption, matched set of words in the transcript, and the sync offset; and
a step of segmenting the captions and applying a prediction model on each segment for predicting possible sync offset of the captions classified as UNDETECTED and updating the result database.

2. The method as claimed in claim 1, comprising a step of filtering the captions from the caption file for removing non-speech content, before comparing each caption with the transcript.

3. The method as claimed in claim 1, comprising a step of determining an initial sync offset for first N captions for converting the captions to a zero-time base.

4. The method as claimed in claim 3, wherein determining the initial sync offset and the zero-time base conversion comprises:
a step of selecting first X captions and their metadata from the result database;
a step of obtaining mode and mode count for the first X captions;
a step of selecting the start time differences of the X captions as the initial sync offset if mode count is greater than 50% of X caption; and
a step of applying the initial sync offset to the captions of the caption file for bringing the caption to the zero-time base.

5. The method as claimed in claim 1, wherein comparing each caption from the caption file with the transcript and assigning the match score based on the result of the comparison comprises:
a step of comparing a caption with a set of N words of the transcript numbered from 0 to N out of M words of the transcript, wherein N is equal to a number of words in the caption;
a step of assigning a score based on a result of the comparison;
a step of repeating the comparison, by considering the caption with a new set of N words formed by 1 to N+1 words of the M words until a highest score is reached; and
a step of assigning the highest score as the match score.

6. The method as claimed in claim 1, wherein each caption from the caption file is classified as one of MATCHING and UNDETECTED by comparing the match score with a predefined threshold match score.

7. The method as claimed in claim 1, wherein segmenting the captions and applying the prediction model on each segment for predicting possible sync offsets of the captions classified as UNDETECTED comprises:
a step of identifying outlier captions in the result database by using z-score method;
a step of extracting training samples from the result database, wherein the training samples include captions having sync offset;
a step of segmenting the training samples based on the sync offset between the MATCHING captions and the matched set of words; and
a step of applying linear regression method on each segment for determining the possible sync offset of the captions classified as UNDETECTED in each of the segments.

8. The method as claimed in claim 7, wherein segmenting the training samples comprises:
a step of calculating z-score for each sample in the training samples;
a step of determining differential z-score by calculating a difference z-score of previous and z-score of next sample;
a step of identifying segments using the differential z-scores.

9. The method as claimed in claim 1, comprising a step of comparing the sync offset of each caption with a predefined value for detecting erroneous captions.

10. The method as claimed in claim 9, wherein the start time and end time of the erroneous captions are corrected using the sync offset stored in the result database.

11. The method as claimed in claim 1, wherein the prediction model is applied if sync error count is greater than or equal to a predefined value.

12. A system for validating captions of a media asset comprising a caption file, wherein each caption having a start time and an end time, the system comprising:
a caption decoder configured for decoding the caption file for generating a format agnostic XML file;
a transcriber engine configured for extracting an audio track from the media asset and transcribing the audio for generating a transcript, wherein each word in the transcript comprises a start time and an end time;
a caption analyser configured for:
comparing each caption with the transcript for identifying matching set of words in the transcript and assigning a match score based on a result of the comparison;
classifying each caption as one of MATCHING and UNDETECTED based on the match score;
determining sync offset between the captions classified as MATCHING and the matched set of words of the transcript, by calculating differences in start time and the end time of each caption classified as MATCHING and the start time and the end time of the matched set of words of the transcript;
storing each caption along with its metadata in a result database, wherein the metadata includes classification of each caption, matched set of words in the transcript, and the sync offset; and
a prediction engine configured for segmenting the captions and applying a prediction model on each segment for predicting possible sync offset of the captions classified as UNDETECTED and updating the result database.

13. The system as claimed in claim 12, comprising a zero-time base conversion module configured for determining initial sync offset and zero-time base conversion.

14. The system as claimed in claim 12, wherein the caption analyser is configured for detecting erroneous captions by comparing the sync offset of each caption with a predefined value.

15. The system as claimed in claim 12, comprising a caption correction module configured for correcting the start time and the end time of the erroneous captions using the sync offset stored in the result database.

16. A non-transitory computer readable medium comprising computer-readable instructions stored in a memory, which when executed by one or more processors enable:
a caption decoder to decode the caption file for generating a format agnostic XML file;
a transcriber engine to extract an audio track from the media asset and to transcribe the audio for generating a transcript, wherein each word in the transcript comprises a start time and an end time;
a caption analyser to:
compare each caption with the transcript for identifying matching set of words in the transcript and assigning a match score based on a result of the comparison;
classify each caption as one of MATCHING and UNDETECTED based on the match score;
determine sync offset between the captions classified as MATCHING and the matched set of words of the transcript, by calculating differences in start time and the end time of each caption classified as MATCHING and the start time and the end time of the matched set of words of the transcript;
store each caption along with its metadata in a result database, wherein the metadata includes classification of each caption, matched set of words in the transcript, and the sync offset; and
a prediction engine to segment the captions and apply a prediction model on each segment for predicting possible sync offset of the captions classified as UNDETECTED and updating the result database.
